(19) United States
(12) Patent Application Publication
(10) Pub. No.: US 2014/0344875 A1
(43) Pub. Date: Nov. 20, 2014

(54) METHOD FOR TRANSMITTING MEDIA DATA HAVING ACCESS UNIT DIVIDED INTO MEDIA FRAGMENT UNITS IN HETEROGENEOUS NETWORK

(71) Applicant: Electronics and Telecommunications Research Institute, Daejeon (KR)

(72) Inventor: Seong Jun Bae, Daejeon (KR)

(21) Appl. No.: 14/373,586

(22) PCT Filed: Jan. 18, 2013
(86) PCT No.: PCT/KR2013/000419

§ 371 Date: Jul. 21, 2014

(30) Foreign Application Priority Data
Jan. 20, 2012 (KR) 10-2012-0006565
Jan. 18, 2013 (KR) 10-2013-0005783

(51) Int. Cl. H04N 21/2381; H04N 21/236; H04N 7/24

(52) U.S. Cl. CPC H04N 21/2381; H04N 7/24; H04N 21/23614
USPC 725/109

(57) ABSTRACT

The present invention generates a media processing unit (MPU) from the component units of media fragment units in configuring a media processing unit, thus achieving the effects of packaging media data corresponding to various media data structures.

### CROSS-REFERENCE TO RELATED APPLICATIONS

This application claims priority to Korean Patent Application No. 10-2012-0006565 filed on Jan. 20, 2012 and No. 10-2013-0005783 filed on Jan. 18, 2013, all of which is incorporated by reference in its entirety herein.

### TECHNICAL FIELD

The present invention relates to a method of transmitting media data, and more particularly, to a method of transmitting coded media data in a system for transmitting coded media data via a heterogeneous IP network.

### BACKGROUND ART

An MPEG-2 system has standardized an MPEG-2 TS (Transport Stream) technology as a standard for functions such as packetization, synchronization, multiplexing, and the like, required for transmitting audio video (AV) contents in a broadcast network, and the MPEG-2 TS technology has been widely used. However, in a new environment in which networks are based on Internet protocol, MPEG-2 TS is ineffective.

Thus, in consideration of a new media transport environment and an anticipated media transmission environment, a new media transport technology is required in a system for transmitting coded media data via a heterogeneous IPC network.

### DISCLOSURE

### Technical Problem

The present invention provides a method for transmitting media data corresponding to various media data structures that may be used according to an SVC-based video layer scheme.

The present invention also provides a structure capable of receiving a media time instance without using an access unit (AU) explicitly.

### Technical Solution

In an aspect, a method for transmitting media data in a system for transmitting coded media data, includes: receiving media data including at least one media fragment unit (MFU) constituting an access unit (AU); and generating a media processing unit (MPU) by using the media fragment unit as a constituent unit.

The MPU may include only MFUs belonging to the same scalable layer.

A number of MFUs included in the MPU may be 1.

The MPU may include information regarding a subset of an MPU including at least one MFU sharing the same media time instance.

The MPU may include an indicator indicating a number of the subsets included in the MPU and an indicator indicating a length of each subset.

The subset may be an AU.

The MPU may further include information regarding any one of transmission and consumption of the MFUs.

In another aspect, a computer-readable recording medium for executing a method for transmitting media data in a system for transmitting coded media data, including receiving media data including at least one media fragment unit (MFU) constituting an access unit (AU) and generating a media processing unit (MPU) by using the media fragment unit as a constituent unit, is provided.

The MPU may include only MFUs belonging to the same scalable layer. A number of MFUs included in the MPU may be 1. The MPU may include information regarding a subset of an MPU including at least one MFU sharing the same media time instance. The MPU may include an indicator indicating a number of the subsets included in the MPU and an indicator indicating a length of each subset. The subset may be an AU. The MPU may further include information regarding any one of transmission and consumption of the MFUs.

In another aspect, an apparatus for transmitting media data in a system for transmitting coded media data, includes: a packaging unit configured to receive media data including at least one media fragment unit (MFU) constituting an access unit (AU), and generate a media processing unit (MPU) by using the MFU as a constituent unit.

The packaging unit may generate the MPU including only MFUs belonging to the same scalable layer.

The MPU may include a single MFU.

The MPU may include information regarding subsets of the MPU including at least one MFU sharing the same media time instance.

The MPU may include an indicator indicating a number of the subsets included in the MPU and an indicator indicating a length of each subset.

The subset may be an AU.

The MPU may further include information regarding at least one of transmission and consumption of the MFUs.

In another aspect, a structure of a media processing unit (MPU) in a system for transmitting coded media data, stores the coded media data by using a media fragment unit (MFU) as a basic unit, wherein the MFU is data having time information or data not having time information.

The MPU structure may include only MFUs belonging to the same scalable layer.

A number of MFUs included in the MPU structure may be 1.

The MPU structure may include information regarding subsets of the MPU including at least one MFU sharing the same media time instance.

The MPU structure may include an indicator indicating a number of the subsets included in the MPU structure and an indicator indicating a length of each subset.

The subset may be an AU.

The MPU structure may further include information regarding at least one of transmission and consumption of the MFUs included in the MFU structure.

### Advantageous Effects

In the case of the method for transmitting media data according to embodiments of the present invention, since a media processing unit is generated by using partial data constituting an access unit (AU), as a data unit, media data corresponding to various media data structures can be packaged.

Also, in the case of the method for transmitting media data according to embodiments of the present invention, since time instance units sharing the same media time instance are used, a media time instance can be used without using an access unit explicitly.

### DESCRIPTION OF DRAWINGS

FIG. 1 is a conceptual view illustrating an MPEG media transport (MMT) layer structure.

FIG. 2 is a conceptual view illustrating a format of unit information (or data or a packet) used in each layer of the MMT layer structure.

FIG. 3 is a conceptual view illustrating a configuration of an MMT package.

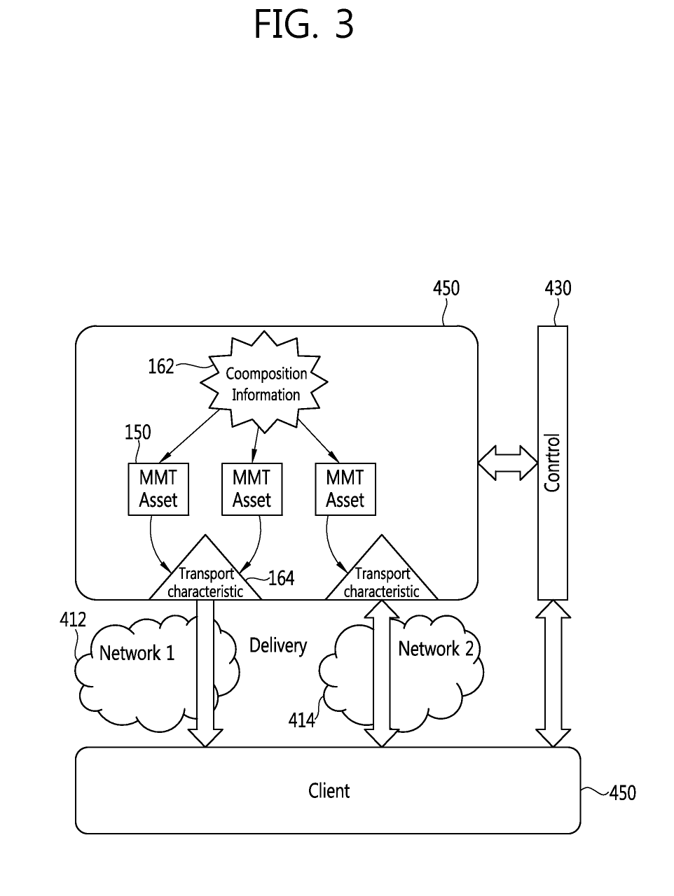

FIG. 4 is a view illustrating a layer structure of an SVC-based layer video.

FIG. 5 is a block diagram of an apparatus for transmitting media data according to an embodiment of the present invention.

FIG. 6 is a flow chart illustrating an operation of the apparatus for transmitting media data according to an embodiment of the present invention.

FIG. 7 is a view illustrating a structure of sequentially storing SVC contents in a media unit according to a method for transmitting media data according to an embodiment of the present invention.

FIG. 8 is a view illustrating a structure of packaging SVC contents into a media unit providing three spatial scalabilities in a progressive downloading manner according to the method for transmitting media data according to an embodiment of the present invention.

FIG. 9 is a view illustrating a structure of packaging SVC contents into a media unit having a minute unit according to the method for transmitting media data according to an embodiment of the present invention.

### MODE FOR INVENTION

The present invention may be embodied in many different forms and may have various embodiments, of which particular ones will be illustrated in drawings and will be described in detail.

However, it should be understood that the following exemplifying description of the invention is not meant to restrict the invention to specific forms of the present invention but rather the present invention is meant to cover all modifications, similarities and alternatives which are included in the spirit and scope of the present invention.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present invention. The term “and/or” encompasses both combinations of the plurality of related items disclosed and any item from among the plurality of related items disclosed.

It will be understood that when an element is referred to as being “connected with” another element, it can be directly connected with the other element or intervening elements may also be present. In contrast, when an element is referred to as being “directly connected with” another element, there are no intervening elements present.

The terms used in the present application are merely used to describe particular embodiments, and are not intended to limit the present invention. An expression used in the singular encompasses the expression of the plural, unless it has a clearly different meaning in the context. In the present application, it is to be understood that the terms such as “including” or “having,” etc., are intended to indicate the existence of the features, numbers, operations, actions, components, parts, or combinations thereof disclosed in the specification, and are not intended to preclude the possibility that one or more other features, numbers, operations, actions, components, parts, or combinations thereof may exist or may be added.

Unless otherwise defined, all terms used herein, including technical or scientific terms, have the same meanings as those generally understood by those with ordinary knowledge in the field of art to which the present invention belongs. Such terms as those defined in a generally used dictionary are to be interpreted to have the meanings equal to the contextual meanings in the relevant field of art, and are not to be interpreted to have ideal or excessively formal meanings unless clearly defined in the present application.

Meanings of terms are defined as follows.

A system for transmitting coded media data through a heterogeneous IP network is referred to as an MPEG media transport (MMT) system.

A content component or media component is defined as a single type of media or a subset of a single type of media. For example, the content component or media component may be a video track, movie subtitles, a video enhancement layer.

The content is defined as a set of contents components and may be, for example, movie, song, or the like.

Presentation is defined as an operation performed by one or more devices to allow a user to experience (e.g., enjoy a movie) one contents component or one service.

Service is defined as one or more contents components transmitted for presentation or storage.

Service information is defined as meta data describing one service and characteristics and components of the service.

Access unit (AU) is the smallest data entity that may have time information as an attribute.

When coded media data for which time information for decoding presentation is not designated is related, the AU is not defined.

MMT asset is a logical data entity configured as at least one MPU together with the same MMT asset ID or configured as a particular data clod together with a format defined in a different standard. MMT asset is the largest data unit to which the same composition information and transmission characteristics are applied.

MMT asset delivery characteristics (MMT-ADC) is description related to QoS requirements for transmitting an MMT asset. MMT-ADC is expressed such that a particular transmission environment is not known.

MMT composition information (MMT CI) describes spatial and temporal relationship between MMT assets.

A media fragment unit (MFU) is a general container, which accommodates coded media data which is independent to any particular codec and independently consumed by a media decoder. The MFU accommodates information that may be used in a transport layer having a size smaller than or equal to that of an AU.

MMT package is a collection of logically structured data, which is comprised of at least one MMT asset, MMT-composition information, MMT-asset transmission characteristics, and descriptive information.

MMT packet is a format of data generated or consumed by an MMT protocol.

MMT payload format is a format for payload of an MMT signaling message or an MMT package to be transmitted by an MMT protocol or an Internet application layer protocol (e.g., an RTP).

Media processing unit (MPU) is a general container independent to any particular media codec, which accommodates information regarding at least one AU and additional transmission and consumption. For non-timed data, MPU accommodates a part of data not belonging to an AU range. MPU is coded media data which is complete and independently processed. In this context, processing refers to encapsulation or packetization into an MMT package for transmission.

Non-timed data defines every data element consumed without specifying time. Non-timed data may have a time range at which data may be executed or starts.

Timed data defines a data element associated with a particular time for decoding and presentation.

Media data refers to a data element including both non-timed data and time data.

Media unit refers to a container including a media fragment unit (MFU) or a media processing unit (MPU).

Hereinafter, an embodiment of the present invention will be described in detail with reference to the accompanying drawings. In describing the present invention, in order to facilitate overall understanding, like reference numerals are used for the same elements and a repeated description of the same elements will be omitted.

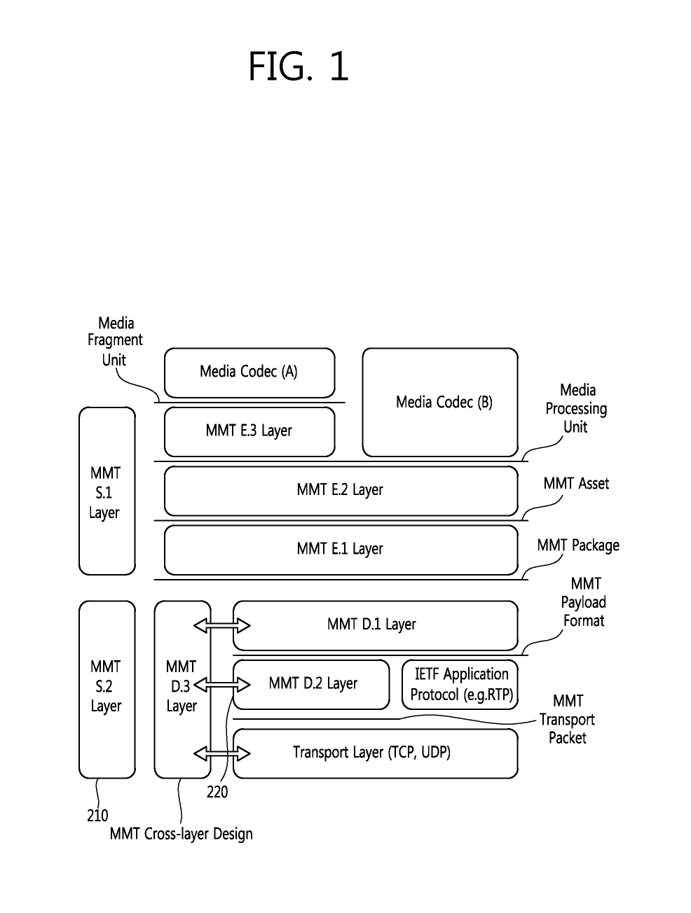

FIG. 1 is a conceptual view illustrating an MMT layer structure.

Referring to FIG. 1, an MMT layer includes an encapsulation layer, a delivery layer, and an S layer. The MMT layer operates above a transport layer.

An encapsulation layer (E-layer) may handle functions of, for example, packetization, fragmentation, synchronization, multiplexing, and the like, of transmitted media.

An encapsulation functional area defines a logical structure of a format of data units to be processed by an entity in compliance with media contents, MMT package, and MMT. In order to provide essential information for an adaptive transmission, the MMT package clarifies components including media contents and relationships therebetween. A format of data units is defined to encapsulate media coded to be stored or transmitted as payload of a transport protocol or easily converted therebetween.

As illustrated in FIG. 1, the E-layer may include an MMT E.1 layer, an MMT E.2 layer, and an MMT E.3 layer.

The E.3 layer encapsulates a media fragment unit (MFU) provided from the media codec (A) layer to generate a media processing unit (MPU).

Coded media data from a higher layer is encapsulated into an MFU. A type and a value of coded media may abstract an MFU such that it can be generally used in a particular codec technique. This allows a lower layer to process an MFU without accessing encapsulated coded media. The lower layer may retrieve requested coded media data from a network or a buffer of a repository and transmit the same to a media decoder. The MFU has an information media part unit sufficient for performing the above operation.

The MFU may have a format which can carry a data unit independently consumed in a media decoder and is independent to a certain particular coded. The MFU may be, for example, a picture or a slice of a video.

An MFU of a plurality of MFUs of a group that can be independently transmitted and decoded generates an MPU. Independently transmittable and executable non-timed media may also generate an MPU. The MPU describes an internal structure such as an arrangement and a pattern of an MPU allowing for a fast access to an MFU and partial consumption thereof.

The E.2 layer encapsulates the MPU generated in the E.3 layer to generate an MMT asset.

The MMT asset is a data entity including one or a plurality of MPUs from a single data source, and is a data unit including defined composition information (CI) and transport characteristics (TC). The MMT asset is multiplexed by an MMT payload format and transmitted by an MMT protocol. The MMT asset may correspond to packetized elementary streams, and may correspond to, for example, a video, an audio, program information, an MPEG-U, a widget, an JPEG image, an MPEG 4 file format, an M2TS (MPEG transport stream), or the like.

The E.1 layer encapsulates the MMT asset generated in the E.2 layer too generate an MMT package.

The MMT asset is packaged together with a different functional region, i.e., a transmission region and a signal region, or may be separately packaged together with MMT composition information for a later response of the same user experience. The MMT package is also packaged together with transmission characteristics of selecting an appropriate transmission method for each MMT asset in order to satisfy quality of experience of an MMT asset.

The MMT package may include one or a plurality of MMT assets together with composition information and additional information such as transport characteristics. The composition information includes information regarding a relationship between MMT assets, and when one contents includes a plurality of MMT packages, the composition information may further include information for indicating a relationship between a plurality of MMT packages. The transport characteristics may include transport characteristics information required for determining a delivery condition of an MMT asset or an MMT asset. The transport characteristics may include, for example, a traffic description parameter and a QoS descriptor. The MMT package may correspond to a program of an MPEG-2 TS.

The delivery layer may perform, for example, network flow multiplexing of media transmitted via a network, network packetization, QoS control, or the like.

The delivery functional area defines an application layer protocol and a format of payload. In the present embodiment, the application layer protocol provides strengthened features for delivering an MMT package in comparison to the related art application layer protocol for transmitting multimedia including multiplexing. The payload format is defined to deliver coded media data irrespective of a media type or encoding method.

As illustrated in FIG. 1, the D-layer may include an MMT D.1 layer, an MMT D.2 layer, and an MMT D.3 layer.

The D.1 layer generates an MMT payload format upon receiving an MMT package generated in the E.1 layer. The MMT payload format is a payload format for transmitting an MMT asset and transmitting information for consumption based on an existing different application transport protocol such as an MMT application protocol or an RTP. The MMT payload may include a fragment of an MFU together with information such as AL-FEC.

The D.2 layer generates an MMT transport packet or an MMT packet upon receiving an MMT payload format generated in the D.1 layer. The MMT transport packet or the MMT packet is a data format used for an application transport protocol for an MMT.

The D.3 layer supports QoS by providing a function of exchanging information between layers by a cross-layer design. For example, the D.3 layer may perform QoS control by using a QoS parameter of a MAC/PHY layer.

The S layer performs a signaling function. For example, the S layer may perform a signaling function for a session initialization/control/management of transmitted media, a server-based and/or client-based trick mode, service discovery, synchronization, or the like.

The signaling functional area defines a format of messages for managing delivery and consumption of an MMT package. The message for managing consumption is used to transmit a structure of an MMT package and the message for managing delivery is used to transmit a structure of a payload format and a configuration of a protocol.

As illustrated in FIG. 1, the S layer may include an MMT S.1 layer and an MMT S.2 layer.

The S.1 layer may perform service discovery, media session initialization/termination, media session presentation/control, an interface function with a delivery (D) layer and an encapsulation (E) layer, and the like. The S.1 layer may define a format of control messages between applications for a media presentation session management.

The S.2 layer may define a format of control messages exchanged between delivery end-points of the D layer regarding a flow control, delivery session management, a delivery session monitoring, an error control, and a hybrid network synchronization control.

The S.2 layer may include signaling for delivery session establishment and release, delivery session monitoring, a flow control, an error control, a resource reservation with respect to a set delivery session, and synchronization in a complex delivery environment, and signaling for adaptive delivery, in order to support an operation of a delivery layer. The S.2 layer may provide signaling required between a sender and a receiver. Namely, the S.2 layer may provide signaling required between a sender and a receiver in order to support an operation of a delivery layer as mentioned above. Also, the S.2 layer may handle an interface function with a delivery layer and an encapsulation layer.

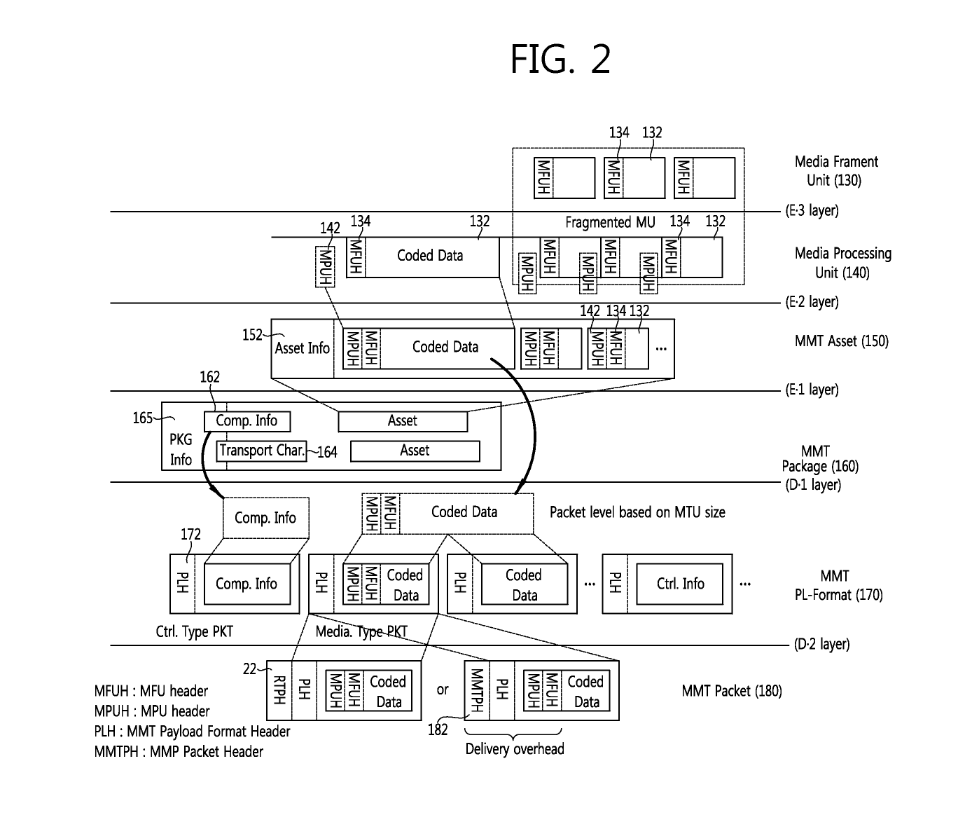

FIG. 2 is a conceptual view illustrating a format of unit information (or data or a packet) used in each layer of the MMT layer structure.

A media fragment unit (MFU) 130 may include coded media fragment data 132 and a media fragment unit header (MFUH) 134. The MFU 130 may carry the smallest data unit which has an independently general container format and may be consumed independently in a media decoder. The MFUH 134 may include additional information such as media characteristics, e.g., loss tolerance. The MFU 130 may be, for example, a picture or a slide of a video.

The MFU may define a format of encapsulating a part of AU in a transport layer in order to perform adaptive transmission within a range of the MFU. The MFU may be used to transmit a certain format of coded media such that a part of an AU is independently decoded or discarded.

The MFU may have an identifier for identifying one MFU from other MFUs and have general relationship information between MFUs within a single AU. A dependent relationship between MFUs in a single AU may be described and relevant priority of an MFU may be described as a part of such information. The information may be used to handle transmission in a lower transport layer. For example, a transport layer may omit transmission of MFUs that may be discarded, in order to support QoS transmission in an insufficient bandwidth. Details of the MFU structure will be described later.

The MPU is a set of media fragment units including a plurality of media fragment units 130. The MPU may have a general container format independent on a particular codec and include media data equivalent to an access unit. The MPU may have a timed data unit or a non-timed data unit.

The MPU is data which is independently and completely processed by an entity following the MMT, and the processing may include encapsulation and packetization. The MPU may include at least one MFU and may have a part of data having a format defined by a different standard.

A single MPU may accommodate an integral number of at least one AU or non-timed data. For timed data, an AU may be delivered from at least one MFU, but one AU cannot be divided into a plurality of MPUs. In non-timed data, one MPU accommodates a part of non-timed data independently and completely processed by an entity in compliance with an MMT.

An MPU may be solely identified within an MMT package by a sequence number and an asset ID identifying it from a different MPU.

The MPU may have at least one arbitrary access point. A first byte of an MPU payload may start with an arbitrary access point all the time. In timed data, the foregoing fact means that decoding order of a first MFU in an MPU payload is 0 all the time. In timed data, a presentation time and decoding order of each AU may be transmitted to inform about a presentation time. An MPU does not have an initial presentation time of its own, and a presentation time of a first AU of one MPU may be described in composition information. The composition information may clarify a first presentation time of an MPU. Details thereof will be described later.

An MMT asset 150 is an MPU set including a plurality of MPUs. The MMT asset 150 is a data entity including a plurality of MPUs (timed or non-timed data). MMT asset information 152 includes asset packaging metadata and additional information such as a data type. The MMT asset 150 may include, for example, a video, audio, program information, MPEG-U widget, a JPEG image, MPEG 4 file format (FF), packetized elementary streams (PES), MPEG transport stream (M2TS), and the like.

The MMT asset is a logical data entity accommodating coded media data. The MMT asset may include an MMT asset head and coded media data. The coded media data may be an aggregational reference group of MPUs by the same MMT asset ID. A type of data that can be individually consumed by an entity directly connected to an MMT client may be considered as an individual MMT asset. Examples of a data type that can be considered as an individual MMT asset may include MPEG-2 TS, PES, MP4 file, MPEG-U widget package, JPEG file, and the like.

Coded media of an MMT asset may be timed data or non-timed data. The timed-data is audio-visual media data. Synchronized decoding and presentation of particular data is required at a designated time. Non-timed data is data of a data type which can be decoded and provided at an arbitrary time according to service providing or user interaction.

A service provider may incorporate MMT assets to generate a multimedia service while leaving the MMT assets in space-time axes.

An MMT package 160 is a set of MMT assets including one or more MMT assets 150. MMT assets of an MMT package may be multiplexed or concatenated like chains.

The MMT package is a container format for MMT asset and configuration information. The MMT package provides a repository of an MMT asset for an MMT program and configuration information.

An MMT program provider generates configuration information by encapsulating coded data into an MMT asset and describing a temporal and spatial layout of the MMT asset and transmission characteristics thereof. The MU and the MMT asset may be directly transmitted in a D.1 payload format. The configuration information may be transmitted by a C.1 presentation session management message. However, the MMT program provider and client permitting relay of the MMT program or a later re-use thereof stores the configuration information in the form of an MMT package.

In parsing an MMT package, the MMT program provider determines a transmission path (e.g., broadcast or broadband) for the MMT asset to be provided to a client. The configuration information in the MMT package is transmitted as a C.1 presentation session management message together with transmission-related information.

The client receives the C.1 presentation session management message and recognizes an available MMT program and how an MMT asset for a corresponding MMT program is received.

The MMT package may also be transmitted in the D.1 payload format. The MMT package is packetized in the D.1 payload format and delivered. The client receives the packetized MMT package, configures the entirety or a portion thereof, and consumes the MMT program.

Package information 165 of the MMT package 160 may include additional information such as configuration information. The configuration information may include a list of MMT assets, a package identification information, composition information 162, and transport characteristics 164. The composition information 162 includes information regarding a relationship between MMT assets 150.

Also, when one contents includes a plurality of MMT packages, the composition information 162 may further include information indicating a relationship between the plurality of MMT packages. The composition information 162 may include information regarding a temporal, spatial, adaptive relationship in the MMT packages.

Like the information helping transmission and presentation of an MMT package, the composition information in an MMT provides information regarding a spatial and temporal relationship between MMT assets in an MMT package.

An MMT-CI is a descriptive language providing such information by extending HTML5. Since HTML5 is designed to describe page-based presentation of text-based contents, an MMT-CI mainly presents a spatial relationship between sources. In order to support presentation indicating a temporal relationship between MMT assets, an MMT-CI may extend to have information regarding an MMT asset present in an MMT package like a presentation resource, temporal information determining transmission of an MMT asset, and consumption order, and an additional attribute of media elements consuming various MMT assets in HTM. Details thereof will be described later.

Transport characteristics information 164 includes information regarding transport characteristics and provide information required for determining a delivery condition of each MMT asset (or MMT packet). The transport characteristics information may include a traffic description parameter and a QoS descriptor.

Traffic description parameter may include information regarding a bit rate with respect to a media fragment unit (MFU) 130 or an MPU, priority information, and the like. The bit rare information may include information, for example, regarding whether an MMT asset has a variable bit rate (VBR) or constant bit rate (CBR), a guaranteed bit rate with respect to an MFU (or an MPU), a maximum bit rate with respect to an MFU (or an MPU). The traffic description parameter may be used to make resource reservation between a server, a client, any other components in a transmission path. For example, the traffic description parameter may include information regarding a maximum size of an MFU (or an MPU) within an MMT asset. The traffic description parameter may be periodically or aperiodically updated.

A QoS descriptor includes information for QoS controlling. For example, the QoS descriptor may include delay information and loss information. The loss information may include a loss indicator regarding whether or not a delivery loss of an MMT asset is permitted. For example, when the loss indicator is 1, it may indicate lossless′, and when the loss indicator is 0, it may indicate lossy′. Delay information may include a delay indicator used to discriminate sensitivity of transmission delay of an MMT asset. The delay indicator may indicate whether a type of an MMT asset is conversion, interactive, real time, or non-realtime.

One contents may include one MMT package. Or, one contents may include a plurality of MMT packages.

When one contents includes a plurality of MMT packages, composition information or configuration information indicating a temporal, spatial, and adaptive relationship among a plurality of MMT packages may be present within or outside one MMT package among MMT packages.

For example, in case of a hybrid delivery, a portion of contents components may be transmitted via a broadcast network and the other remaining portion of the contents components may be transmitted via a broadband network.

For example, in case of a plurality of audiovisual (AV) streams constituting one multi-view service, one stream may be transmitted via a broadcast network and the other stream may be transmitted via a broadband network. Each AV stream may be multiplexed and individually received by and stored in a client terminal. Or, for example, a scenario in which application software such as widget is transmitted via a broadband network and an AV stream AV program) is delivered via an existing broadcast network may exist.

In the case of the multi-view service scenario and/or the widget scenario, the entirety of a plurality of AV streams may become a single MMT package, and in this case, one of the plurality of AV streams may be stored only in a single client terminal, storage contents becomes a part of an MMT package, the client terminal should rewrite composition information or configuration information, and the rewritten contents is a new MMT package irrespective of a server.

In the case of the multiview service scenario and/or widget scenario, each AV stream may become a single MMT package, and in this case, a plurality of MMT packages constitute single contents and recorded by MMT package unit in a storage, and composition information or configuration information indicating a relationship among MMT packages is required.

The composition information or configuration information included in a single MMT package may refer to an MMT asset of a different MMT package, or may present the exterior of an MMT package referring to the MMT package in an out-band situation.

Meanwhile, in order to information a client terminal about a path available for delivering a list of MMT assets 150 provided by the service provider and an MMT package 160, the MMT package 160 is translated into service discovery information through a control (C) layer, so an MMT control message may include an information table for a service discovery.

A server, which has fragmented multimedia contents into a plurality of segments, assigns URL information to a predetermined number of the plurality of fragmented segments, stores URL information regarding each segment in a media information file, and transmits the same to a client.

The media information file may be called various names such as ‘media presentation description (MPD)’, ‘manifest file’, or the like, according to standardization organization standardizing HTTP streaming. Hereinafter, the media information file will be designated as a media presentation description (MPD) and described.

Hereinafter, a cross layer interface (CLI) will be described.

A CLI is exchanging QoS related information between lower layers including an application layer and a MAC/PHY layer, in which a means supporting QoS is provided in a single entity. A lower layer provides upstream QoS information such as a network channel state, while an application layer provides information regarding media characteristics as downstream QoS information.

The CLI provides an interface integrated between an application layer and various network layers including IEE802.11 WiFi, IEEE 802.16 WiMAX, 3G, 4G LTE, and the like. Common network parameters of popular network standards are excerpted into a NAM parameter for static and dynamic QoS control of real-time media applications through various networks. The NAM parameter may include a bit error rate (BER) value. A BER may be measured from a PHY or a MAC layer. Also, the NAM provides identification of a lower network, an available bit rate, a buffer state, a peak bit rate, a service unit size, and a service data unit loss rate.

Two different methods may be used to provide NAM. A first method is providing an absolute value. A second method is providing a relative value. The second method may be used for the purpose of updating NAM.

An application layer provides downstream QoS information related to media characteristics with respect to a lower layer. Two types of downstream information such as MMT asset level information and packet level information exist. The MMT asset information is used to capacitor exchange and/or resource (re)allocation in a lower layer. The packet level downstream information is recorded in an appropriate field of every packet for a lower layer to allow a supported QoS level to be recognized.

The lower layer provides upstream QoS information to the application layer. The lower layer provides information regarding a network state which allows the application layer to more rapidly and accurately control QoS and changes over time. The upstream information is presented in an abstracted form to support a heterogeneous network environment. Such parameters are measured in the lower layer and read by the application layer periodically or according to a request from the MMT application.

Hereinafter, a media processing unit (MPU) and a media unit (M-unit) according to an embodiment of the present invention will be described. The MPU may be used as a media unit, and the media unit may be used as an MPU. Hereinafter, a description of the M-unit may also be applied to the MPU in the same manner.

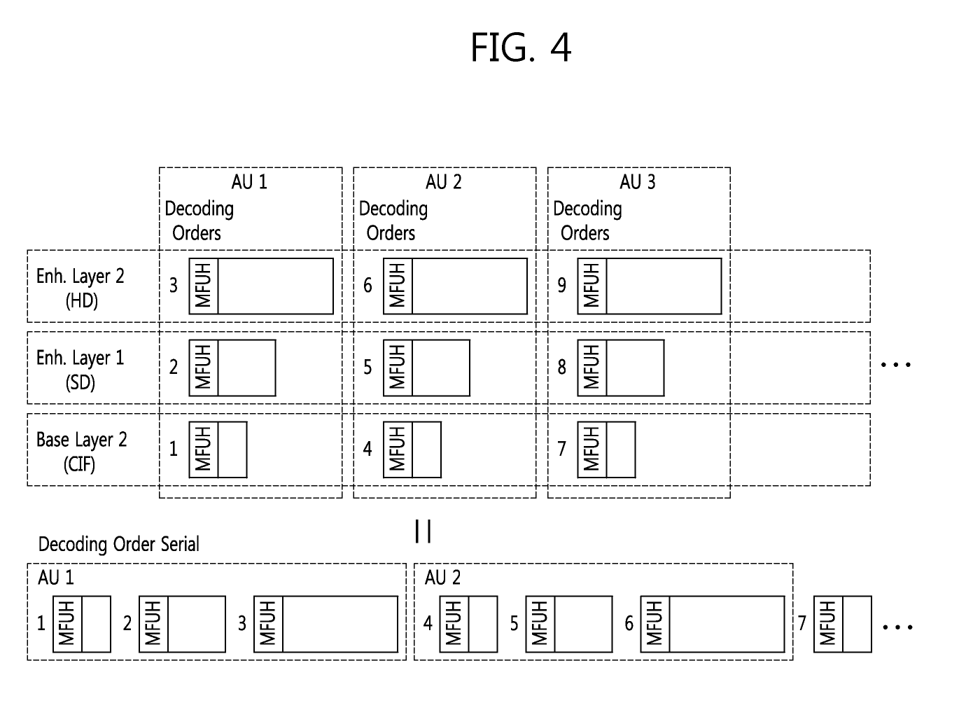

FIG. 4 is a view illustrating a relationship between an MFU and an AU in case of having three layers (CIF resolution, SD resolution, and HD resolution). Here, a single network abstraction layer (NAL) unit may be accommodated in a single media fragment unit (MFU). In the embodiment of FIG. 4, as for decoding order of the NAL unit stream, in a single AU, decoding is performed from the lower layer CIF to the higher layer HD, and from a first AU to a next AU. Thus, decoding order as illustrated may be decided. First, second and third MFUs of AU1 are decoded, fourth, fifth, and sixth MFUs of AU2 are decoded, and seventh, eighth, and ninth MFUs of AU3 are sequentially decoded.

The M-unit according to an embodiment of the present invention accommodates one or two or more media fragment units (MFUs) in a general container format not dependent on a particular codec. A single M-unit may include an MFU as data having time information or data not having time information, and may additionally include additional information helping transmission or additional information helping data processing (or consumption).

The M-unit may include only an MFU as a fragment of an AU, rather than the entire unit of the at least one AU. Thus, a minimum unit of the M-unit may not be limited to an AU and may accommodate at least one fragment of a single AU.

Also, a structural design of the M-unit may be modified to have a structure for including a media time instance without explicitly using an AU.

Or, the M-unit may include one or two or more access units (AU) in a general container format not dependent on a particular codec. Here, the AU may include at least one MFU, and a single M-unit may include information regarding an additional transmission and consumption for an AU as data having time information or data not having time information and an AU transmitted by the M-unit. The M-unit may include at least one AU and additional information for synchronization and a random access point.

The M-unit is a data entity to be processed in an MMT encapsulation layer. The generated M-unit is encapsulated in the encapsulation layer and generated as an MMT asset.

Hereinafter, time information of a media unit according to an embodiment of the present invention will be described. When an AU is not explicitly described in an M-unit structure, an M-unit may be required to include a media time instance such as composition timestamp (CTS) or decoding timestamp (DTS).

Here, rather than directly describing an AU within the M-unit, a media time instance structure may be described in an M-unit structure, and a number of media time instances in an M-unit and a data section corresponding to each time instance may be indicated.

In order to discriminate each time instance (CTS or DTS) in an M-unit, a new conceptual discrimination unit may be used instead of an AU. A common media time instant unit (CMTU) may be used as a discrimination unit.

The CMTU may include a subset of an M-unit payload including at least one MFU sharing the same media time instance. Components constituting an M-unit may be unified into an MFU so as to be simplified. Accordingly, a hierarchical structure of the MMT may be considerably simplified and formed to be intuitive.

A header structure of a media unit (M-unit) generated in a method for transmitting media data according to an embodiment of the present invention will be described. In order to describe a media time instance by using an CMTU instead of AU, content corresponding to AU among header information of the M-unit may be used as follows. Here, a header of the M-unit may have a field as shown in Table 1. As described above, a header of the MPU may have a field as shown in Table 1.

Although not shown, a header may have a decoding order field indicating a decoding order of AUs or CMTUs included in an M-unit. When the decoding order field is not stated, the AUs or CMTUs are arranged in decoded order. Also, the header may have subsample_start_id and subsample_end_id fields. An AU or a CMTU may include at least one MFU, and an MFU has a sequence ID identifying the MFU from other MFUs. The subsample_start_id and subsample_end_id fields may indicate a sequence ID of a start MFU and an ID of an end MFU to indicate a continuous range of MFUs constituting an AU or CMTU.

TABLE 1

| Field name | Semantics |
|---|---|
| mu_length | It indicates length of M-unit |
| header_length | It indicates a header length of M-unit |
| rap_flag | It indicates that there is an access unit as at least one |
| | random access point in M-unit |
| | Decoding of M-unit may happen at the beginning of M- |
| | unit all the time |
| | 0b: It indicates that there is no random access point in |
| | M-unit |
| | 1b: there is an access unit as at least one random |
| | access point in M-unit |
| mu_sequence_number | It indicates a sequence number of corresponding M-unit. |
| | It is increased by 1 each time and has a unique value in |
| | an asset stream. This value may be used in a |
| | transmission region in order to request retransmission of |
| | a particular MU. |
| number_of_CMTU | It indicates number of CMTUs included in a |
| | corresponding M-unit |
| CMTU_length | It indicates a length of each CMTU included in a |
| | corresponding M-unit |
| private_header_flag | It indicates whether a corresponding M-unit has a private |
| | header |
| | 0b: there is no private header |
| | 1b: there is a private header |
| private_ehader_length | It indicates a length of private header when |
| | private_header_flag is set to 1. |

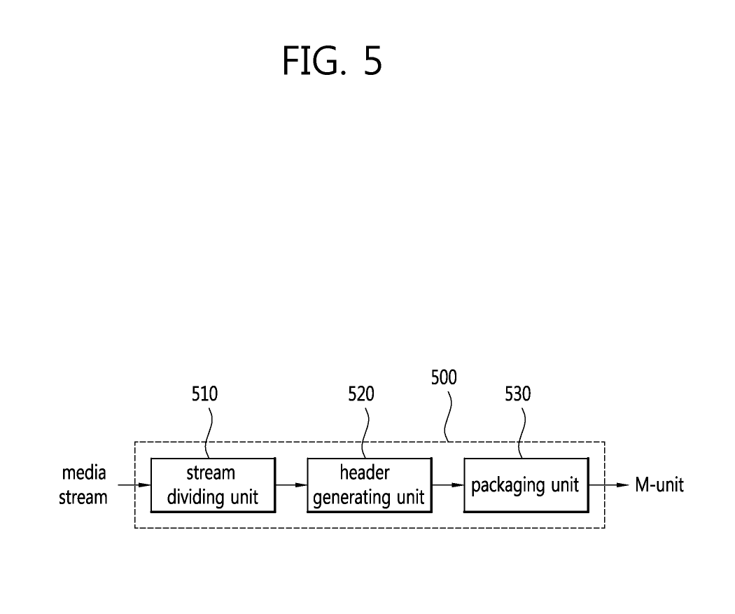

FIG. 5 is a block diagram of an apparatus for transmitting media data according to an embodiment of the present invention. The apparatus 500 for transmitting media data includes a stream dividing unit 510, a header generating unit 520, and a packaging unit 530. The apparatus 500 for transmitting media data receives media data and generates an M-unit.

The stream dividing unit 510 divides media data into MFU units, and delivers the same to the packaging unit 520. The header generating unit 520 generates a header of the M-unit, and the header may have a header structure of Table 1 described above. The packaging unit 530 collects the divided MFUs to generate an M-unit.

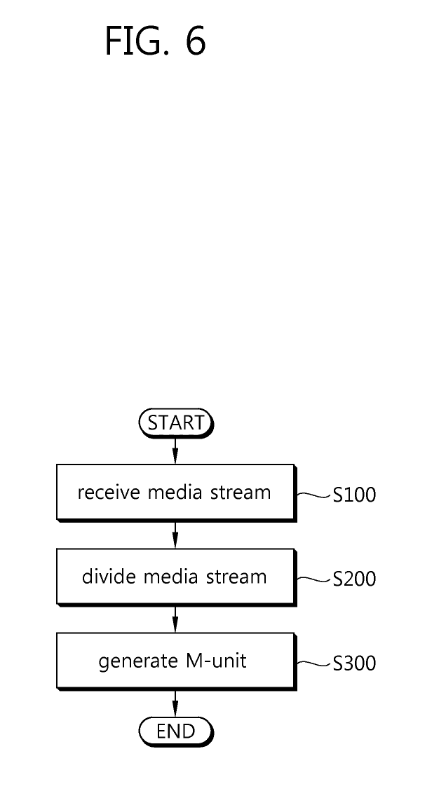

FIG. 6 is a flow chart illustrating an operation of the apparatus for transmitting media data according to an embodiment of the present invention. First, the apparatus 500 for transmitting media data receives media data (S100). The stream dividing unit 510 divides the media data into MFU units accommodating an NAL unit (S200). Thereafter, an M-unit is generated (S300). The header generating unit 520 generates a header of the M-unit, and the packaging unit 530 collects the divided MFUs to generate an M-unit (S300). A header field of the M-unit may include time information. Also, the M-unit may include information regarding additional transmission and consumption as described above. This method may also be applied to an MPU.

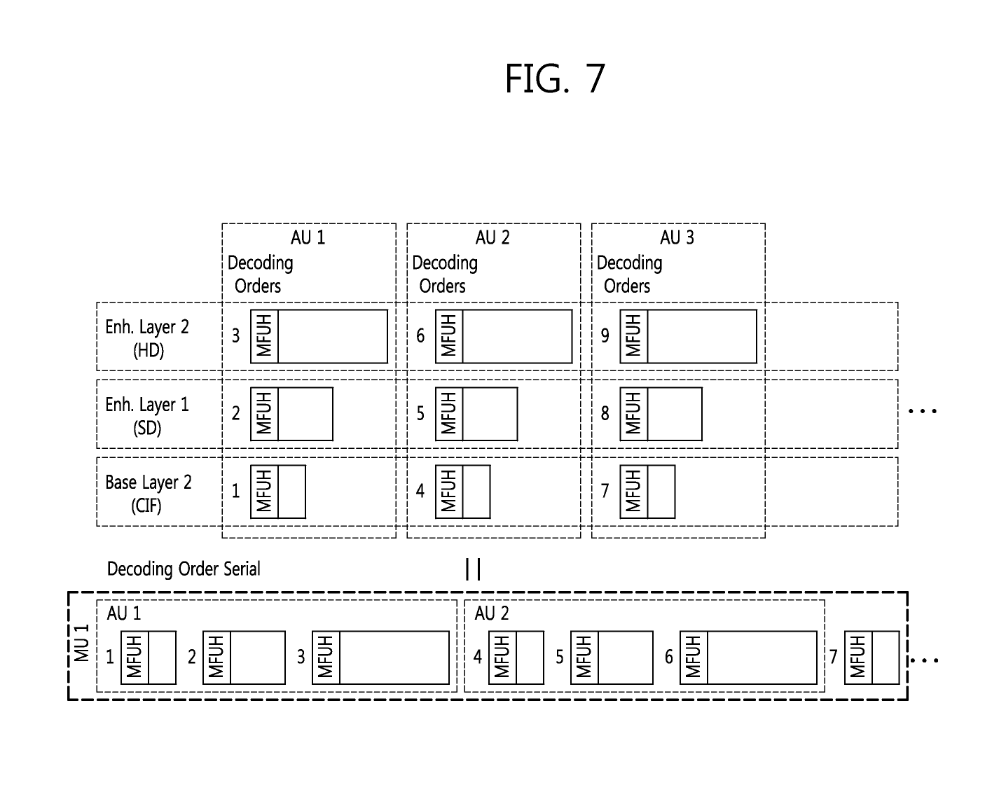

FIG. 7 is a view illustrating a structure of sequentially storing SVC contents in a media unit according to a method for transmitting media data according to an embodiment of the present invention. FIG. 7 illustrates a structure of sequentially storing SVC contents in an M-unit. In this case, in the structure, a plurality of AUs are accommodated in a single M-unit, and the structure may be used in an example of configuring an M-unit by GOP units or according to an IDR period. A plurality of access units may be accommodated in the M-unit at intervals of GOP or IDR.

Each access unit may sequentially store MFUs of a base layer (CIF), an enhancement layer 1 (SD), and an enhancement layer 2 (HD). According to an embodiment of FIG. 7, first, second, and third MFUs of AU1 are decoded, fourth, fifth, and sixth MFUs of AU2 are decoded, and seventh, eighth, and ninth MFUs of AU3 are sequentially decoded. The structure of the M-unit may be used in case that scalable layer is not required to be discriminated in a transmission environment such as progressive download in which transmission is performed by chunk on a TCP. This scheme may also be applied to an MPU.

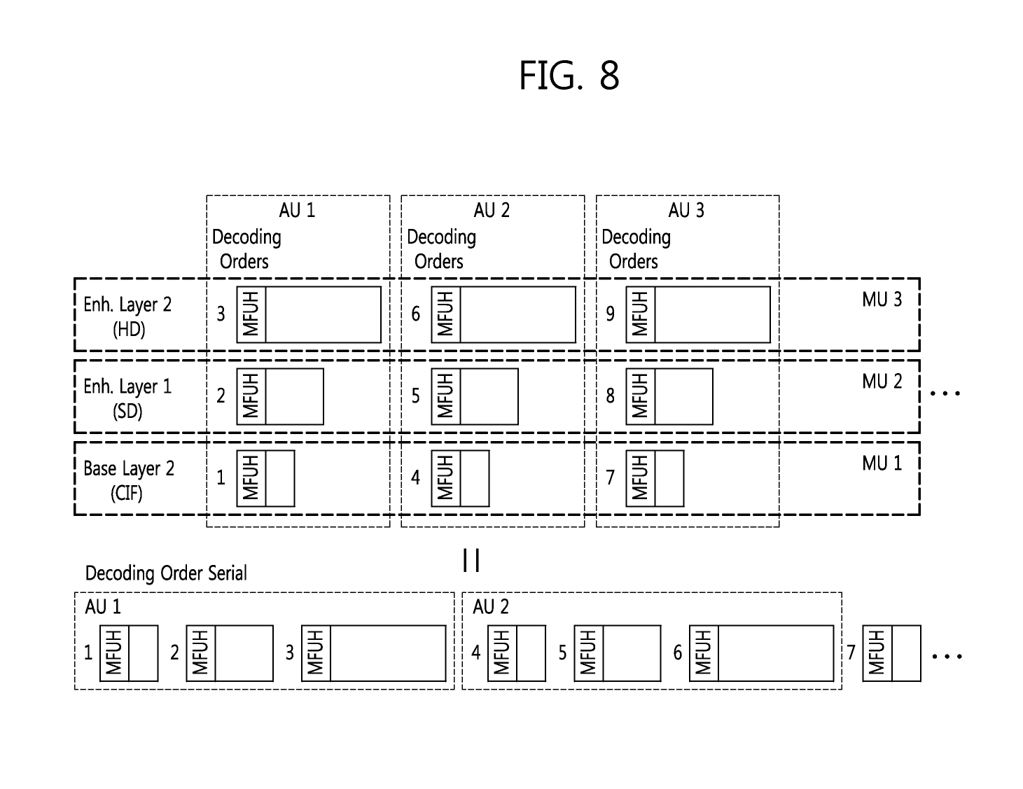

FIG. 8 is a view illustrating a structure of packaging SVC contents into a media unit providing three spatial scalabilities in a progressive downloading manner according to the method for transmitting media data according to an embodiment of the present invention. FIG. 8 illustrates an M-unit providing three spatial scalabilities in a progressive download method. All the MFUs belonging to the same scalable layer may be included in the same M-unit, and each scalable layer may correspond to a dedicated M-unit.

Third, sixth, and ninth MFUs, MFUs of the enhancement layer 2 HD layer, are included in MU3. Similarly, second, fifth, and eighth MFUs of enhancement layer 1 SD layer are included in MU2, and first, fourth, and seventh MFUs of base layer CIF layer are included in MU1.

Through the M-unit structure, a receiving client may download an appropriate combination of M-units to configure every available scalability layer. This scheme may also be applied to an MPU.

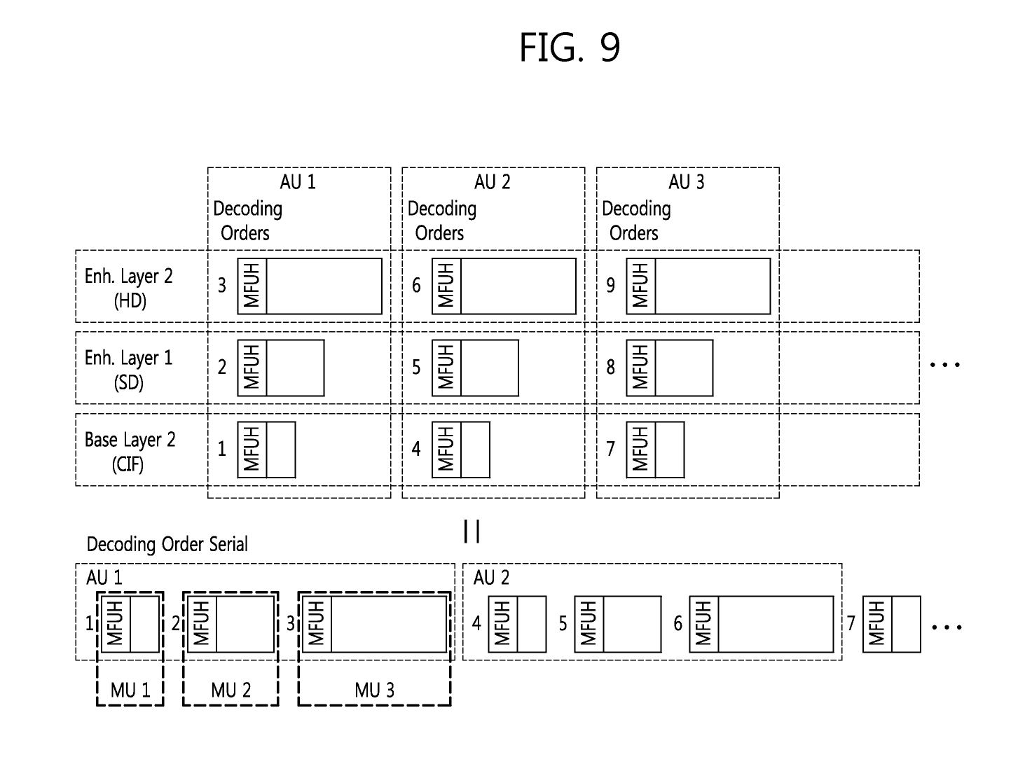

FIG. 9 is a view illustrating a structure of packaging SVC contents into a media unit having a minute unit according to the method for transmitting media data according to an embodiment of the present invention. FIG. 9 illustrates an example of configuring an M-unit by the most minute unit with an SVC video bit stream. MU1 includes a first MFU. Similarly, MU2 includes a second MFU. Other MUs include a single MFU. In this case, each M-unit includes a single MFU. This structure is appropriate for minimizing a lost data part in case of a packet error-generated UDP streaming (or in case of transmitting by RTP on UDP). This scheme may also be applied to an MPU.

1. A method for transmitting media data in a system for transmitting coded media data, the method comprising:
receiving media data including at least one media fragment unit (MFU) constituting an access unit (AU); and
generating a media processing unit (MPU) by using the media fragment unit as a constituent unit.

2. The method of claim 1, wherein the MPU includes only MFUs belonging to the same scalable layer.

3. The method of claim 1, wherein a number of MFUs included in the MPU is 1.

4. The method of claim 1, wherein the MPU includes information regarding a subset of an MPU including at least one MFU sharing the same media time instance.

5. The method of claim 4, wherein the MPU includes an indicator indicating a number of the subsets included in the MPU and an indicator indicating a length of each subset.

6. The method of claim 5, wherein the subset is an AU.

7. The method of claim 5, wherein the MPU further includes information regarding any one of transmission and consumption of the MFUs.

8. A computer-readable recording medium recording a program for executing a method of claim 1 in a computer.

9. An apparatus for transmitting media data in a system for transmitting coded media data, the apparatus comprising:
a packaging unit configured to receive media data including at least one media fragment unit (MFU) constituting an access unit (AU), and generate a media processing unit (MPU) by using the MFU as a constituent unit.

10. The apparatus of claim 9, wherein the packaging unit generates the MPU including only MFUs belonging to the same scalable layer.

11. The apparatus of claim 9, wherein the MPU includes a single MFU.

12. The apparatus of claim 9, wherein the MPU includes information regarding subsets of the MPU including at least one MFU sharing the same media time instance.

13. The apparatus of claim 12, wherein the MPU includes an indicator indicating a number of the subsets included in the MPU and an indicator indicating a length of each subset.

14. The apparatus of claim 13, wherein the subset is an AU.

15. The apparatus of claim 14, wherein the MPU further includes information regarding at least one of transmission and consumption of the MFUs.

16. A structure of a media processing unit (MPU) in a system for transmitting coded media data, wherein the structure stores the coded media data by using a media fragment unit (MFU) as a basic unit, wherein the MFU is data having time information or data not having time information.

17. The structure of claim 16, wherein the MPU structure includes only MFUs belonging to the same scalable layer.

18. The structure of claim 16, wherein a number of MFUs included in the MPU structure is 1.

19. The structure of claim 16, wherein the MPU structure includes information regarding subsets of the MPU including at least one MFU sharing the same media time instance.

20. The structure of claim 19, wherein the MPU structure includes an indicator indicating a number of the subsets included in the MPU structure and an indicator indicating a length of each subset.

21. The structure of claim 20, wherein the subset is an AU.

22. The structure of claim 16, wherein the MPU structure further includes information regarding at least one of transmission and consumption of the MFUs included in the MFU structure.
